(19) United States
(12) Patent Application Publication
(10) Pub. No.: US 2021/0227789 A1
(43) Pub. Date: Jul. 29, 2021

(54) ANIMAL TRAINING APPARATUS AND SYSTEM

(71) Applicant: E-Collar Technologies, Inc., Garrett, IN (US)

(72) Inventors: Greg Van Curen, Fremont, IN (US); Ho-Sung So, Seoul (KR)

(73) Assignee: E-Collar Technologies, Inc., Garrett, IN (US)

(21) Appl. No.: 16/750,688

(22) Filed: Jan. 23, 2020

(51) Int. Cl. A01K 15/02; A01K 27/00

(52) U.S. Cl. CPC A01K 15/021; A01K 27/009; A01K 15/029; A01K 27/006; A01K 27/001

(57) ABSTRACT

An animal training apparatus according to an aspect of the present invention is worn on an animal to deliver stimulation, and includes a main stimulation module configured to generate an intensity adjustable main stimulation and deliver the main stimulation to the animal, an auxiliary stimulation module configured to generate a different type of auxiliary stimulation from the main stimulation and deliver the auxiliary stimulation to the animal, and a microprocessor configured to control the main stimulation module and the auxiliary stimulation module to deliver the main stimulation and/or the auxiliary stimulation to the animal when a preset condition is satisfied, wherein when delivery of the main stimulation exceeding a maximum intensity is required, the microprocessor is configured to control the main stimulation module and/or the auxiliary stimulation module to automatically generate the maximum intensity of main stimulation and the auxiliary stimulation together.

### FIELD OF THE INVENTION

The present disclosure relates to an electronic animal training apparatus and system that is worn on the body of an animal such as a dog or a cat to deliver stimulation to train the animal or correct the animal's behavior.

### BACKGROUND OF THE INVENTION

In the field of animal training, owners or trainers (hereinafter referred to as ‘users’) have employed various electric and electronic technologies in correcting animal behaviors since the late 1960s. For example, Patent Literature 1 (U.S. Pat. No. 6,131,535) discloses a control method of an animal training device including a collar type receiver worn on the neck of an animal, and a transmitter or a remote controller possessed by a user to conduct radio-frequency wireless communications with the receiver, to allow the user to control the receiver to deliver stimulation such as electrical stimulation to an animal through the transmitter when the animal does a behavior that needs to be corrected, such as barking, going beyond a preset boundary or attacking a human.

Patent Literature 1 discloses a system including the receiver having a vibration motor and a high voltage generator embedded therein to deliver vibration stimulation and high-voltage electrical stimulation respectively, and the transmitter having a mode selector to allow the user to select a vibration mode for delivering vibration stimulation, an impulse wave mode for delivering electrical stimulation or a vibration/impulse wave mode for delivering vibration stimulation and electrical stimulation together.

Using such electronic animal training devices or systems, animals may learn good behaviors. Also, electronic animal training devices or systems have advanced by employing electronic and communication technologies that are developing day by day, and are gaining excellent effects in training hunting dogs or pets.

However, despite the advancement of technologies, improvements are still needed. For example, according to the system of Patent Literature 1, the user can adjust the intensity of electrical stimulation to deliver according to the animal's behavior, and select the type or mode of stimulation to deliver. However, in many cases, the animal's behavior changes so instantaneously that there is not enough time for the user to select a proper intensity, type or mode of stimulation to immediately correct (prohibit) the animal's behavior. That is, when the user selects a proper intensity, type or mode of stimulation and manipulates the transmitter, the animal might have already done a bad behavior (for example, a behavior that harms a human). Additionally, a system including a training device (collar) that is worn on an animal's body without a remote controller or a transmitter can deliver a programmed intensity of electrical stimulation according to a signal from a sensor that senses the animal's behavior (for example, barking), but cannot select the type or mode of stimulation.

### SUMMARY

The present disclosure provides an animal training apparatus and system for effectively correcting an animal's behavior even in an emergency.

An animal training apparatus according to an aspect of the present disclosure is worn on an animal to deliver stimulation for correcting the animal when the animal does or does not do a particular behavior, and includes a main stimulation generator/stimulator module configured to generate an intensity adjustable main stimulation and deliver the main stimulation to the animal, an auxiliary stimulation generator/stimulator module configured to generate a different type of auxiliary stimulation from the main stimulation and deliver the auxiliary stimulation to the animal, and a microprocessor configured to control the main stimulation generator/stimulator module and the auxiliary stimulation generator/stimulator module to deliver the main stimulation and/or the auxiliary stimulation to the animal when a preset condition is satisfied, wherein when delivery of the main stimulation exceeding a maximum intensity is required, the microprocessor is configured to control the main stimulation generator/stimulator module and/or the auxiliary stimulation generator/stimulator module to automatically generate the maximum intensity of main stimulation and the auxiliary stimulation together.

In this instance, the main stimulation may be electrical stimulation, and the auxiliary stimulation may be vibration stimulation and/or sound stimulation.

The animal training apparatus may further include a sensor to detect whether the animal did or did not do the particular behavior, and the microprocessor may determine whether the preset condition is satisfied based on a signal outputted from the sensor.

The microprocessor may be configured to control the main stimulation generator/stimulator module to generate the main stimulation with a higher intensity by a predetermined intensity than a current intensity, when the main stimulation generator/stimulator module repeatedly generates the main stimulation within a predetermined time.

The animal training apparatus may further include a memory, and the microprocessor may store an operation history in the memory, the operation history including a time at which the animal training apparatus operated and an intensity of stimulation at that time.

The maximum intensity may be set by a user.

An animal training system according to another aspect of the present disclosure includes an animal training apparatus worn on an animal to deliver stimulation to the animal and a remote controller possessed by a user to control the animal training apparatus, the remote controller and the animal training apparatus are configured to communicate with each other via wireless communication, the animal training apparatus includes a main stimulation generator/stimulator module configured to generate an intensity adjustable main stimulation and deliver the main stimulation to the animal, an auxiliary stimulation generator/stimulator module configured to generate a different type of auxiliary stimulation from the main stimulation and deliver the auxiliary stimulation to the animal, a wireless communication module configured to receive a signal from the remote controller, and a microprocessor configured to control the main stimulation generator/stimulator module and the auxiliary stimulation generator/stimulator module to deliver the main stimulation and/or the auxiliary stimulation to the animal based on the signal received by the wireless communication module, and the remote controller includes a user input means to select a particular stimulation mode from a plurality of stimulation modes differing in type, intensity or duration of the stimulation to be delivered by the animal training apparatus or a particular function from a plurality of functions provided by the animal training system and input an execution command of the selected stimulation mode or function, a wireless communication module to transmit signals indicating the stimulation mode or function selected by the user input means to the animal training apparatus, and a microprocessor to process the signals and control the wireless communication module, wherein when the stimulation mode or function selected by the user input means requires delivery of the main stimulation exceeding a maximum intensity, the microprocessor of the remote controller controls to transmit a signal for delivering the maximum intensity of main stimulation and the auxiliary stimulation together to the animal training apparatus through the wireless communication module of the remote controller.

In this instance, the main stimulation may be electrical stimulation, and the auxiliary stimulation may be vibration stimulation and/or sound stimulation.

The user input means of the remote controller may include a dial to adjust the intensity of the main stimulation to be delivered to the animal, and when the user sets the intensity exceeding the maximum intensity using the dial and inputs an execution command to deliver the main stimulation, the microprocessor of the remote controller may control to transmit a signal for delivering the maximum intensity of main stimulation and the auxiliary stimulation together to the animal training apparatus.

The plurality of stimulation modes may include Boost Mode in which the intensity of the main stimulation to be delivered to the animal that is higher than a currently set intensity by a predetermined amount is delivered, and when the user inputs an execution command of the Boost Mode and the intensity increased by the predetermined amount in the Boost Mode is the intensity exceeding the maximum intensity, the microprocessor of the remote controller may control to transmit a signal for delivering the maximum intensity of main stimulation and the auxiliary stimulation together to the animal training apparatus.

The remote controller may further include a memory, and the microprocessor of the remote controller may store an operation history in the memory, the operation history including a time at which the animal training apparatus operated and an intensity of stimulation at that time.

The maximum intensity may be set by the user through the user input means.

According to an aspect of the present disclosure, even a system including only an animal training apparatus that is impossible for the user to control all the time since it has no remote controller may effectively correct the animal's behavior by automatically delivering auxiliary stimulation in addition to main stimulation in an emergency situation.

Additionally, the animal training system according to another aspect of the present disclosure may automatically deliver auxiliary stimulation in addition to main stimulation, thereby effectively correcting the animal's behavior without physical, temporal and psychological burden involved in changing the stimulation mode using a stimulation mode selection switch or precisely adjusting stimulation intensity in an emergency situation, in particular, when the user is unable to use two hands freely.

Furthermore, according to an embodiment, an operation history of the animal training apparatus is stored in the memory, so the user can check when and how often the corresponding animal did a behavior that needs to be corrected and if proper correction is given and the currently set stimulation intensity is proper, through an external terminal.

### BRIEF DESCRIPTION OF DRAWINGS

FIG. 1 is a perspective view illustrating an animal training apparatus according to an exemplary embodiment of the present disclosure and an external computer terminal for settings of the animal training apparatus.

FIG. 2 is a block diagram illustrating components of the animal training apparatus shown in FIG. 1.

FIG. 3 is a perspective view illustrating an animal training system according to another exemplary embodiment of the present disclosure.

FIG. 4 is a block diagram illustrating components of the animal training apparatus shown in FIG. 3.

FIG. 5 is a block diagram illustrating components of a remote controller shown in FIG. 3.

FIG. 6 shows an enlarged diagram (a) of a display of a remote controller shown in FIG. 3 and a table (b) describing each icon on the display.

FIG. 7 shows waveform diagrams illustrating a pulse waveform of electrical stimulation delivered to an animal for each stimulation mode in an animal training system shown in FIG. 3.

### DETAILED DESCRIPTION

Hereinafter, an animal training apparatus and an animal training system according to the present disclosure is described in detail with reference to the accompanying drawings.

It should be understood that the terms or words used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. The embodiments described herein and illustrations shown in the drawings are just a most preferable embodiment of the present disclosure but are not intended to fully describe the technical aspects of the present disclosure, so it should be understood that other equivalents and modifications could be made thereto at the time of filing the application.

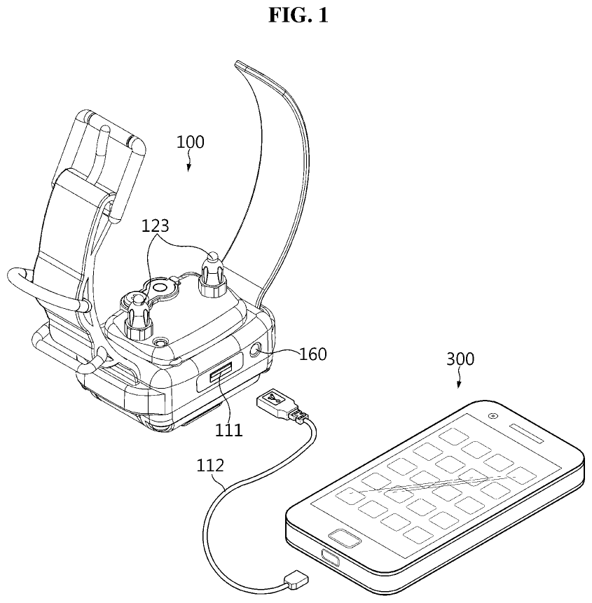

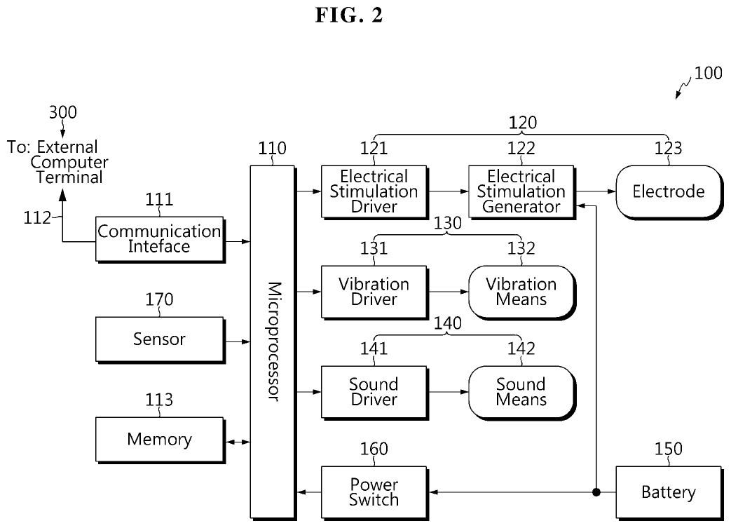

FIG. 1 is a perspective view illustrating an animal training apparatus according to an exemplary embodiment of the present disclosure and an external computer terminal for settings of the animal training apparatus, and FIG. 2 is a block diagram of the animal training apparatus.

The animal training apparatus 100 of this embodiment shown in FIGS. 1 and 2 is a general electronic animal training apparatus used to train an animal (typically, a dog, but the present disclosure is not limited thereto) or correct the animal's behavior, and is usually worn around the animal's neck. Thus, the animal training apparatus 100 includes the components of a general animal training apparatus, for example, a stimulation generator/stimulator module, a microprocessor, a battery, and a necessary sensor.

The stimulation generator/stimulator module includes a stimulator means and its driver employed by a general electronic animal training apparatus, and stimulation includes electrical stimulation, vibration stimulation and sound stimulation.

The stimulation generator/stimulator module for delivering electrical stimulation to the animal is implemented as an electrical stimulation generator/stimulator module 120, and specifically, may include an electrical stimulation driver 121, an electrical stimulation generator 122, and an electrode 123.

The electrical stimulation driver 121 converts a signal of stimulation instructed by a microprocessor 110 to an analog signal recognizable by the electrical stimulation generator 122 and outputs the same to drive the electrical stimulation generator 122. The electrical stimulation generator 122 generates an electrical pulse having current of, for example, from about 50 μA to about 100 mA and voltage of from about 50V to about 10,000V using a transformer. The electrode 123 is a stimulator means which comes into contact with the animal's body (typically, the neck) to deliver the electrical pulse generated by the electrical stimulation generator 122 to the animal. The microprocessor 110 may variously adjust the electrical stimulation delivered to the animal by adjusting the intensity (amplitude, voltage), frequency, duration (pulse width), interval, pulse ratio, duty cycle, and repetition ratio of the electrical pulse through the electrical stimulation driver 121 based on the specifications of the electrical stimulation generator 122.

The stimulation generator/stimulator module for delivering vibration stimulation to the animal is implemented as a vibration stimulation generator/stimulator module 130, and specifically, may include a vibration driver 131 and a vibration means 132.

The vibration driver 131 converts a signal of stimulation instructed by the microprocessor 110 to a signal recognizable by the vibration means 132 and outputs the same to drive the vibration means 132. The vibration means 132 is implemented as a vibration motor or a piezoelectric device to generate a vibration pulse. The microprocessor 110 may variously adjust the vibration stimulation delivered to the animal by adjusting the intensity (amplitude), frequency, duration (pulse width), interval, pulse ratio, duty cycle, and repetition ratio of the vibration pulse through the vibration driver 131 based on the detailed specifications of the vibration means 132.

The stimulation generator/stimulator module for delivering sound stimulation to the animal is implemented as a sound stimulation generator/stimulator module 140, and specifically, may include a sound driver 141 and a sound means 142.

The sound deriver 141 converts a signal of stimulation instructed by the microprocessor 110 to a signal recognizable by the sound means 142 and outputs the same to drive the sound means 142. The sound means 142 is implemented as a buzzer, a piezoelectric device or a speaker to generate a sound pulse of frequency audible to the animal. The microprocessor 110 may variously adjust the sound stimulation delivered to the animal by adjusting the intensity (amplitude), frequency, duration (pulse width), interval, pulse ratio, duty cycle, and repetition ratio of the sound pulse through the sound driver 141 based on the specifications of the sound means 142.

Besides, light from a light-emitting diode (LED) lamp or smell using chemicals may be used as a stimulation source. Each of the drivers 121, 131, and 141 and each stimulation generator/stimulator means 122, 132, and 142 driven by the drivers is logically distinguished, and may be physically incorporated into one device.

A battery 150 supplies required power to each component of the animal training apparatus 100, especially the microprocessor 110 and the stimulation generator/stimulator module 120, 130, and 140, and preferably includes a rechargeable secondary battery. In this case, the battery 150 may be charged using a universal serial bus (USB) port 111 as described below.

A power switch 160 is a power switch which switches ON/OFF the animal training apparatus 100.

Although not shown in the drawing, the animal training apparatus 100 may be equipped with a display to display a remaining amount of the battery 150 or the type or mode of the stimulator means currently in operation.

A sensor 170 detects the animal's behavior such as barking and a motion, and may include various types of sensors based on a specific behavior intended to detect.

For example, when the animal training apparatus 100 of the present disclosure is used as an animal behavior correcting apparatus which detects an animal barking, and to train the animal not to bark, delivers stimulation to the animal, the sensor 170 may be a piezoelectric sensor which detects vocal cords of the animal vibrating or a microphone which detects the animal barking.

Also, when the animal training apparatus 100 of the present disclosure is used as an animal behavior correcting apparatus which detects an animal going out of a preset area or approaching the area, and to train the animal not to do so, delivers stimulation to the animal, the sensor 170 may be a sensor that senses a signal (electromagnetic wave, ultrasonic wave, infrared light, and so on) from a transmitter (a wire buried in the ground or a radio-frequency, ultrasonic or infrared transmitter installed at a point) installed at the area or its boundary, or an image sensor that senses a particular mark installed at the area or its boundary.

Further, the sensor 170 may be a gyro sensor or an acceleration sensor that detects a motion of an animal. In this case, the microprocessor 110 may control to change the animal training apparatus 100 to a sleeping mode when the motion sensor 170 does not output a signal for a predetermined time or longer, namely, when the animal does not move for a predetermined time or longer, or on the contrary, when the animal's motion or barking is detected, wake up the animal training apparatus 100 from the sleeping mode.

The microprocessor 110 controls the operation of the animal training apparatus 100 including the stimulation generator/stimulator module 120, 130, and 140. The microprocessor 110 is typically implemented as an integrated circuit (IC) chip, and may have a necessary memory 113 or register, and the operation of the microprocessor 110 may be implemented as control logic programmed in software, firmware, and a hardwired logic.

The memory 113 preferably includes a non-volatile memory device, and stores a program that defines the operation of the microprocessor 110 or data such as the set condition. Additionally, each time the animal training apparatus 100, in particular, the stimulation generator/stimulator module 120,130,140 operates, the memory 113 may store an operation history including the time of operation and the intensity or mode of stimulation at that time. The stored operation history allows the user to check when and how often the corresponding animal did a behavior that needs to be corrected and if proper correction is given and the currently set intensity or mode of stimulation is proper when the user see the operation history through an external terminal such as a computer terminal or a smartphone.

The microprocessor 110 receives an input of the signal from the sensor 170, and when a preset condition is satisfied, that is, for example, the intensity of the signal from the sensor 170 exceeds a preset reference value, the microprocessor 110 controls the stimulation generator/stimulator module 120, 130, and 140 to deliver stimulation to the animal. In this instance, when the intensity of the signal from the sensor 170 exceeds the preset reference value, the microprocessor 110 may control the stimulation generator/stimulator module 120, 130, and 140 to deliver stimulation with a preset type, duration, and/or intensity of stimulation, or may be programmed to deliver stimulation with varying types, durations, and/or intensities of stimulation based on the intensity of the signal from the sensor 170.

In this embodiment, the microprocessor 110 may be configured to allow the user to set or change at least part of the control logic. The control logic that may be set or changed by the user includes the type of main stimulation and auxiliary stimulation, the stimulation mode and the maximum intensity of the main stimulation, taking into account the size of the animal on which the animal training apparatus 100 is to be worn, the training level and sensitivity to stimulation.

The settings or changes may be accomplished through a separate switch or button provided in the animal training apparatus 100, but is preferably accomplished through the external computer terminal 300 which is electrically connected to the animal training apparatus 100. To do so, the animal training apparatus 100 includes a communication interface to electrically connect the microprocessor 110 to the external computer terminal 300. Although the communication interface is implemented of a wired communication type including a USB port 111 and a USB communication cable 112 in the examples of FIGS. 1 and 2, the communication interface may be implemented of a wireless communication type such as, for example, Bluetooth.

Furthermore, for settings/changes of the control logic, an application program is installed in the external computer terminal 300 electrically connected to the animal training apparatus 100 with the communication interface to retrieve the control logic of the microprocessor 110 and change the same in response to an input from the user. Although the examples shown in FIGS. 1 and 2 illustrate the external computer terminal 300 as a smartphone, it is obvious that the external computer terminal may include a desktop computer, a laptop computer and a tablet computer. The set/changed control logic may be stored in the memory 113.

In this embodiment, when delivery of main stimulation exceeding the maximum intensity is required, the microprocessor 110 is configured to control the main stimulation generator/stimulator module and the auxiliary stimulation generator/stimulator module to automatically generate the maximum intensity of main stimulation and auxiliary stimulation of a type that is different from the main stimulation together. Here, at least the intensity of the main stimulation may be adjusted from 0 to the maximum intensity set or changed as described above.

Specifically, in this embodiment, the main stimulation is electrical stimulation, and the auxiliary stimulation is vibration stimulation. However, the present disclosure is not limited to this combination of main stimulation and auxiliary stimulation, and the main stimulation may be electrical stimulation, and the auxiliary stimulation may be vibration stimulation or sound stimulation, and further, the main stimulation may be stimulation that is different from electrical stimulation.

In the present disclosure, delivery of main stimulation exceeding the maximum intensity is required, for example, in the following situation.

When the animal wearing the animal training apparatus 100 does a behavior that needs to be corrected, as the preset condition is satisfied, a preset intensity of main stimulation (electrical stimulation) is delivered by the main stimulation generator/stimulator module (the electrical stimulation generator/stimulator module), and after that, the animal does not do the same behavior for a predetermined time, the microprocessor 110 may be programmed to decrease the preset intensity, or on the contrary, when the animal repeats the same behavior within the predetermined time, may be programmed to generate and deliver a higher intensity of main stimulation than the current intensity by a predetermined increase in intensity. In this case, particularly, as a result of increased intensity caused by repetition of the same behavior within the predetermined time, delivery of the main stimulation exceeding the preset maximum intensity is required.

In this instance, according to this embodiment, the microprocessor 110 may control the main stimulation generator/stimulator module (the electrical stimulation generator/stimulator module) and the auxiliary stimulation generator/stimulator module (the vibration stimulation generator/stimulator module) to automatically generate and deliver the maximum intensity of main stimulation (electrical stimulation) and auxiliary stimulation (vibration stimulation) together.

According to this embodiment, even a system including only the animal training apparatus that is impossible for the user to control all the time since it has no remote controller may effectively correct the animal's behavior by automatically delivering auxiliary stimulation in addition to main stimulation in an emergency situation.

Additionally, the following supplementary effect can be expected from the use of vibration stimulation as the auxiliary stimulation. That is, the animal training apparatus 100 is worn on the animal's body (typically, the neck) such that the electrode 123 that delivers electrical stimulation is in as close contact with the animal's skin as possible, and as time goes or the animal moves, hair having higher electrical resistance than the skin exists between the electrode 123 and the skin. Accordingly, the intensity of electrical stimulation becomes lower than the previously set intensity, and the delivered vibration stimulation may allow for improved contact of the electrode 123 with the skin without interference of the hair.

Although the embodiment described hereinabove shows that the present disclosure consists of only an animal training apparatus, the present disclosure may be applied to an animal training system including a remote controller possessed by a user and an animal training apparatus worn on an animal Hereinafter, an animal training system according to another embodiment of the present disclosure is described.

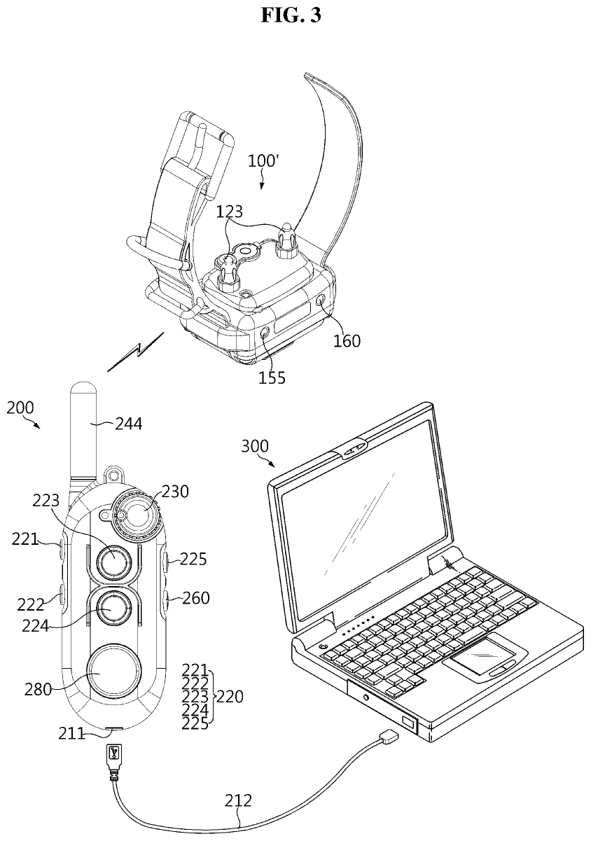

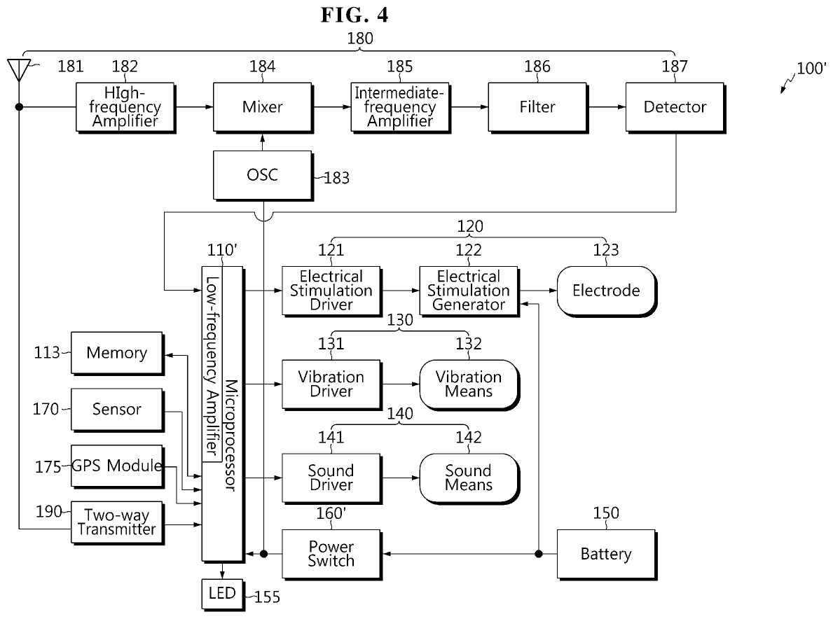

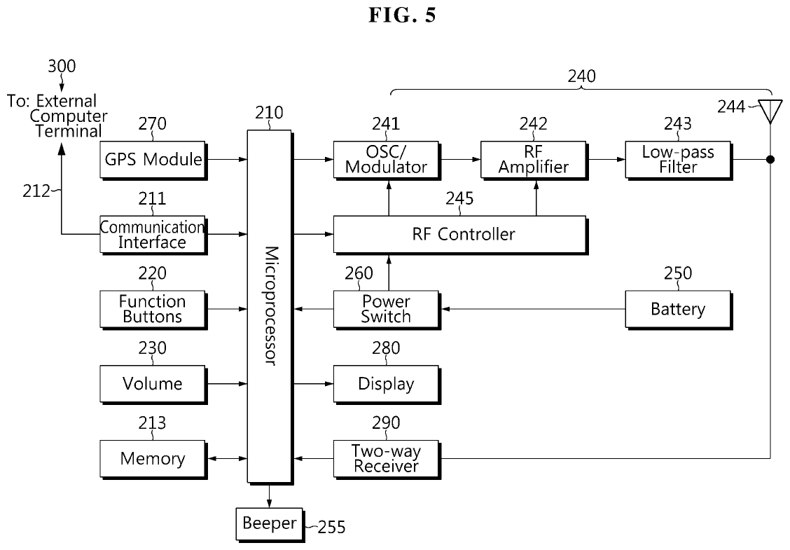

FIG. 3 is a perspective view illustrating an animal training system according to another exemplary embodiment of the present disclosure, and FIGS. 4 and 5 are block diagrams respectively illustrating the components of the animal training apparatus 100′ and the remote controller 200 shown in FIG. 3.

Referring to FIG. 3, the animal training system of this embodiment includes a training apparatus 100′ worn on an animal to deliver stimulation for correcting the animal when the animal does a bad behavior, and a remote controller 200 possessed by a user to control the animal training apparatus 100′, and the remote controller 200 and the animal training apparatus 100′ are configured to conduct wireless communications with each other.

The animal training apparatus 100′ of this embodiment has a basic structure nearly similar to the animal training apparatus 100 of the previous embodiment. A key difference is that the animal training apparatus 100′ of this embodiment has a wireless communication module 180 for wireless communications with the remote controller 200, and the user does not need to directly set/change the function of the animal training apparatus 100′, so the animal training apparatus 100′ does not need to have a communication interface (111 and 112 in the previous embodiment). The animal training apparatus 100′ may have a USB port as a terminal for charging the battery 140. Also, a microprocessor 110′ is slightly different in the detailed configuration from the microprocessor 110 of the animal training apparatus 100 as described previously. The following description of the animal training apparatus 100′ of this embodiment will be focused on differences from the animal training apparatus 100 described previously.

As shown in FIG. 4, the wireless communication module 180 added to the animal training apparatus 100′ of this embodiment includes an antenna 181, a radio-frequency amplifier 182, an oscillator 183, a mixer 184, an intermediate-frequency amplifier 185, a filter 186, and a detector 187. The antenna 181 receives RF signals transmitted from the remote controller 200, and the radio-frequency amplifier 182 amplifies weak RF signals induced into the antenna 181. The oscillator 183 is a self-oscillator for obtaining second intermediate frequency, and signals generated by the oscillator 183 are combined with the RF signals from the radio-frequency amplifier 182 by the mixer 184 into second intermediate frequency signals. The intermediate-frequency amplifier 185 amplifies the intermediate frequency signals produced from the mixer 184, and the filter 186 filters out noise from the intermediate frequency signals produced from the mixer 184. The detector 187 detects operation signals and control signals such as ID codes sent from the remote controller 200, and the detected control signal is inputted to the microprocessor 110′ through a low-frequency amplifier.

Although not necessary, the animal training apparatus 100′ of this embodiment may have a global positioning system (GPS) module 175 or a two-way transmitter 190. The GPS module 175 receives signals from a satellite, and inputs location information of the animal to the microprocessor 110′. The two-way transmitter 190 transmits the location information of the animal or information associated with the animal training apparatus 100′ such as remaining amount information of the battery 140 to the remote controller 200 through the antenna 181.

The microprocessor 110′ receives an input of the control signal from the remote controller 200 through the wireless communication module 180, and controls the operation of the stimulation generator/stimulator module 120, 130, and 140. That is, in this embodiment, the microprocessor 110′ passively operates under the control of the remote controller 200 as opposed to the microprocessor 110 of the previous embodiment.

Although not necessary, the animal training apparatus 100′ may have a sensor 160 in the same way as the previous embodiment. In this case, the microprocessor 110′ may actively operate to deliver stimulation to the animal based on signals from the sensor 160, similar to the microprocessor 110 of the previous embodiment. However, transition to an active operation mode itself is made by the user under the control of the remote controller 200.

Also, although not necessary, the animal training apparatus 100′ may have a lighting means 155 such as a LED lamp. The lighting means 155 is a means that is turned on at night to implement a function of allowing for easy detection of the location of the animal (the animal training apparatus), rather than a source of stimulation to be delivered to the animal. The activation/deactivation of the lighting function of the lighting means 155 (to detect the location of the animal training apparatus) and settings/changes of the lighting time may be made under the control of the remote controller 200 by the user.

The remote controller 200 of this embodiment is a transmitter possessed by the user in a general animal training system. Thus, the remote controller 200 has elements of a general remote controller for setting/selecting the stimulation mode or executing various functions, for example, a button or a switch, a microprocessor, a battery and a display.

That is, referring to FIGS. 3 and 5, the remote controller 200 has a user input means to select the stimulation mode including the type, duration and/or intensity of stimulation to be delivered by the animal training apparatus 100′ or select functions provided by the animal training system and input an execution command, a wireless communication module 240 to transmit signals indicating the stimulation mode or function selected by the user input means to the animal training apparatus, a microprocessor 210 to process the signals and control the wireless communication module 240, a battery 250, and a power switch 260.

The user input means includes a plurality of buttons 220 or switches and a dial 230 to set the type, intensity and duration of stimulation to be delivered to the animal through the animal training apparatus 100′. The dial 230 is a switch which adjusts the currently selected intensity of main stimulation, and the function buttons 220 are used to select the type of stimulation and input an execution command, initialize or register the remote controller 200 or the animal training apparatus 100′, or change the settings, and a detailed description will be provided together with the stimulation mode. The dial 230 is an input means used for the user to adjust the stimulation intensity (level) as desired by rotating it with his/her finger while seeing the stimulation intensity displayed on the display 280, and the rotating dial 230 may be replaced with up/down buttons.

The wireless communication module 240 includes an oscillator/modulator 241, a radio frequency (RF) amplifier 242, a low-pass filter 243, an antenna 244 and a RF controller 245. The oscillator/modulator 241 modulates signals inputted from the microprocessor 210 that will be transmitted by a wireless communication method, and the RF amplifier 242 amplifies RF signals from the oscillator/modulator 151. The low-pass filter 243 blocks harmonics other than the fundamental waves in the amplified RF signals, and the antenna 244 transmits the RF signals composed of the fundamental waves having passed through the low-pass filter 243. Also, the RF controller 245 supplies power to operate the oscillator/modulator 241 and the RF amplifier 242 so as to transmit control signals to the animal training apparatus 100′ in response to the input from the user through the user input means of the remote controller 200.

The battery 250 supplies required power to each component of the remote controller 200, especially the microprocessor 210 and the wireless communication module 240, and preferably includes a rechargeable secondary battery. In this case, the battery 250 may be charged using a USB port 211 as described below.

The power switch 260 is a switch which switches ON/OFF the remote controller 200.

The remote controller 200 of this embodiment may further include a display 280. The display 280 displays the type, intensity and duration of stimulation selected/set by the user input means or the settings of the remote controller 200 or the animal training apparatus 100′, and further, the remaining amount of the battery 250 of the remote controller 200.

Although not necessary, the remote controller 200 of this embodiment may have a GPS module 270 or a two-way receiver 290. The GPS module 270 receives signals from a satellite and displays location information of the user or the remote controller on the display 280. Also, as described above, when the animal training apparatus 100′ has the GPS module 175 and the two-way transmitter 190 and transmits current location information of the animal or remaining amount information of the battery 140 of the animal training apparatus 100′ to the remote controller 200, the GPS module 270 may also display a distance from the user to the animal and its direction, a movement speed of the animal, and remaining amount information of the battery 140 of the animal training apparatus 100′ on the display 280.

The remote controller 200 of this embodiment may further include a beeper 255 or a light emitting means (not shown) such as a LED lamp. The beeper 255 or light emitting means may be used for the user to detect the location of the remote controller 200.

The microprocessor 210 controls the entire operation of the animal training system including the animal training apparatus 100′ and the remote controller 200. The microprocessor 210 is typically implemented as an IC chip, and may have a necessary memory 213 or register, and the operation of the microprocessor 210 may be implemented as control logic programmed in software, firmware, and a hardwired logic.

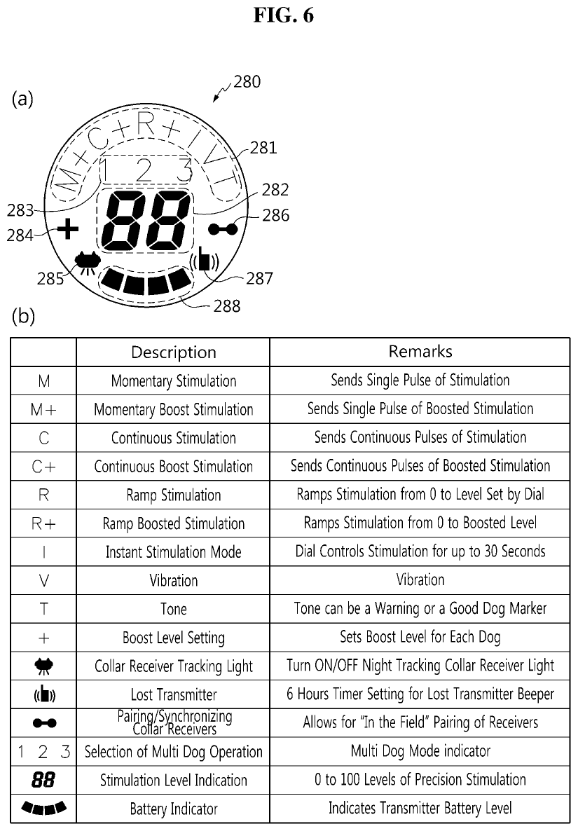

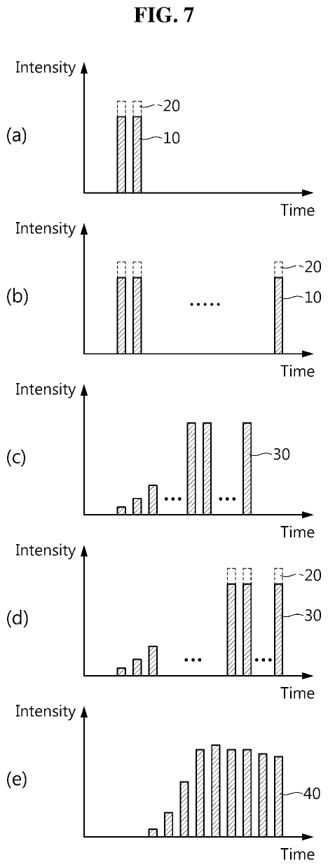

Subsequently, the operation of the microprocessor 210 is described in detail with reference to FIGS. 6 and 7 together with the user input means, the display 280 and the stimulation mode.

First, as shown in (a) of FIG. 6, the display 280 displays the settings of the remote controller 200 or the animal training apparatus 100′ and the stimulation mode in the form of icons 281˜288 or a text using a LCD or LED. That is, when a corresponding mode or function is selected, or based on a current condition, each icon 281˜288 is selectively lighted up. The stimulation mode or function represented by each icon 281˜288 on the display 280 is described in the table as shown in (b) of FIG. 6, and a detailed description is as follows.

The icons 281 of English alphabet and symbol ‘+’ arranged at the upper part of the display 280 represent each mode of stimulation (especially, electrical stimulation as main stimulation) delivered by the animal training apparatus 100′.

Specifically, among the icons 281, ‘M’ is lighted up to indicate a mode (Momentary Stimulation Mode, hereinafter simply referred to as ‘M Mode’) in which electrical stimulation of a level (intensity) currently set by the dial 230 is momentarily delivered (in the form of single-cycle or few-cycle pulses) through the electrode 123 of the animal training apparatus 100′. Each time the function button (any one of 221˜225) assigned to the stimulation mode is pressed, the stimulation mode is executed for a preset short time (e.g., 1˜3 seconds) irrespective of the period of time during which the button is pressed (see Reference Numeral 10 in (a) of FIG. 7).

Among the icons 281, ‘C’ is lighted up to indicate a mode (Continuous Stimulation Mode, hereinafter briefly referred to as ‘C Mode’) in which electrical stimulation of a level (intensity) currently set by the dial 230 is delivered through the electrode 123 of the animal training apparatus 100′ while the corresponding button (any one of 221˜225) is being pressed (see Reference Numeral 10 in (b) of FIG. 7).

Among the icons 281, ‘R’ is lighted up to indicate a mode (Ramp Mode, hereinafter briefly referred to as ‘R Mode’) in which electrical stimulation automatically increasing from level 0 to a level (intensity) currently set by the dial 230 for a preset time (e.g., 1 second) and subsequently fixed to the level is delivered through the electrode 123 of the animal training apparatus 100′ while the corresponding button (any one of 221˜225) is being pressed (see Reference Numeral in (c) of FIG. 7).

Among the icons 281, a ‘+’ icon are lighted up together with ‘M’, ‘C’, and ‘R’ (such as ‘M+’, ‘C+’, ‘R+’) to indicate a mode (Boost Mode, hereinafter respectively referred to as ‘M+ Mode’, ‘C+ Mode’, and ‘R+ Mode’) in which electrical stimulation of a level that is higher by a preset level than a level (intensity) currently set by the dial 230 in each stimulation mode (M, C, and R modes) is delivered through the electrode 123 of the animal training apparatus 100′ (see Reference Numeral 20 in (a), (b), and (d) of FIG. 7).

Among the icons 281, ‘I’ is lighted up to indicate a mode (Instant Mode, hereinafter referred to as ‘I Mode’) in which electrical stimulation changing from level 0 to a level (intensity) currently set by the dial 230 is delivered only by the dial 230 without continuously pressing the corresponding button 221˜225 through the electrode 123 of the animal training apparatus 100′ (see Reference Numeral 40 in (e) of FIG. 7). Entry into this stimulation mode is accomplished by adjusting the dial 230 to set the stimulation level to 0 and short-pressing the corresponding button (any one of 221˜225), and afterwards, the stimulation mode continues by the adjustment of the dial 230 and ends when the dial 230 is reduced to 0 or after a preset time (e.g., 30 seconds) passes. This mode is useful in adjusting the dial 230 based on the animal's response to find a stimulation level suitable for the corresponding animal, and in particular, it is convenient in a situation where the user has difficulty in using both hands.

Among the icons 281, ‘V’ is lighted up to indicate a mode (Vibration Mode, hereinafter referred to as ‘V Mode’) in which vibration stimulation is delivered while the corresponding button (any one of 221˜225) is being pressed through the vibration means 132 of the animal training apparatus 100′.

Among the icons 281, ‘T’ is lighted up to indicate a mode (Tone Mode, hereinafter referred to as a ‘T Mode’) in which sound stimulation is delivered through the sound means 142 of the animal training apparatus 100′ while the corresponding button (any one of 221˜225) is being pressed.

Generally, vibration stimulation and sound stimulation is less stimulative to the animal than electrical stimulation when used singly, and in some instance, may be stimulation pleasant for the animal. Thus, vibration stimulation or sound stimulation may be used before delivering main stimulation (electrical stimulation) or may be used to encourage, compliment or caution the animal, based on a behavior level of the animal. However, when vibration stimulation or sound stimulation is used together with main stimulation (electrical stimulation), especially, with the maximum intensity of electrical stimulation, the stimulation is magnified and acts as a powerful control means for the animal's behavior.

In the above mentioned stimulation modes, particularly C, R, I, V, and T modes, stimulation is continuously delivered to the animal while the corresponding button is pressed or the dial 230 is adjusted, and as a result, in some instances, excessive stimulation may be delivered. To prevent this, a maximum value of stimulation duration (e.g., 10˜30 seconds) may be set irrespective of a period of time during which the button or dial is pressed or adjusted, and the maximum value may be changed.

Two 7-segment icons 282 at the center of the display 280 indicate the intensity (level) of main stimulation currently set or delivered immediately before, and in this embodiment, the main stimulation, electrical stimulation, is divided into 100 total levels from 0 to 99, and fine control may be taken based on the sensitivity of the animal to stimulation.

A number icon 283 disposed between the alphabet icon 281 and the 7-segment icon 282 indicates the animal training apparatus 100′ (i.e., the animal) selected currently or immediately before, when a plurality of animal training apparatuses 100′ may be simultaneously controlled with one remote controller 200 (i.e., a plurality of animals may be simultaneously trained with one remote controller 200).

A ‘+’ icon 284 disposed at the left part of the display 280 is lighted up when the level increasing at a predetermined amount is set or changed in the above mentioned Boost Mode (M+, C+, and R+ modes).

An animal training apparatus shaped icon 285 disposed at the lower right side of the ‘+’ icon 284 is lighted up when a function of detecting the location of the animal by lighting the light emitting means 155 of the animal training apparatus 100′ especially at night is performed.

A dumbbell shaped icon 286 disposed at the right part of the display 280 is lighted up when pairing and synchronization of the animal training apparatus 100′ and the remote controller 200 is performed.

A remote controller shaped icon 287 disposed at the lower left side of the dumbbell shaped icon 286 is lighted up when a function of automatically operating the beeper 255 of the remote controller 200 when a preset time passes to let the user know the location of the remote controller 200 is performed.

Lastly, an icon 288 disposed below the display 280 is an icon indicating a remaining amount of the battery 250 of the remote controller 200.

The shape or arrangement, and further, the type of each of the icons 281˜288 on the display 280 is provided for illustration only and may be changed or added (for example, displaying the location of the animal training apparatus 100′ or the remote controller 200 acquired by the GPS modules 175 and 270). Also, the stimulation modes or functions indicated by each of the icons may be changed according to particular embodiments.

The memory 213 preferably includes a non-volatile memory device, and stores a program that defines the operation of the microprocessor 210 or data such as the set condition. Additionally, each time the animal training apparatus 100′ is operated through the remote controller 200, the memory 213 may store an operation history including the time of operation and the intensity or mode of stimulation at that time. The stored operation history allows the user to check when and how often the corresponding animal did a behavior that needs to be corrected and if proper correction is given and the currently set intensity of stimulation is proper when the user sees the operation history through an external terminal such as a computer terminal or a smartphone.

To this end, the remote controller 200 includes a communication interface to electrically connect the microprocessor 210 to the external terminal. Although the communication interface is implemented of a wired communication type including a USB port 211 and a USB communication cable 212 in the example shown in FIGS. 3 and 5, the communication interface may be implemented of a wireless communication type, such as, for example, Bluetooth. Additionally, the USB port 211 and the USB communication cable 212 may be used to charge the battery 250.

Further, the user may change the functions assigned to each function button 221˜225, set or change the activation/deactivation of a particular function or condition, or set or change at least part of the control logic of the microprocessor 210, using the communication interface and a proper application or the user input means 220,230. That is, the user may execute the application on the external terminal connected by the communication interface, or enter the programming mode of the animal training system by long-pressing a particular button (for example, 225) of the remote controller 200 (for example, 1 sec or longer), and set/change the button assignment, set/change the above-described stimulation mode, set/change and activate/deactivate the above-described function and set/change the maximum intensity using the particular button 220 or the dial 230 while seeing the display 280.

In the same way as the animal training apparatus 100 of the above-described embodiment, when delivery of main stimulation exceeding the maximum intensity is required, the animal training system of this embodiment is configured to automatically deliver auxiliary stimulation of a type that is different from the main stimulation together with the main stimulation of the maximum intensity. In this embodiment, this process is implemented by controlling the animal training apparatus 100′ through the remote controller 200.

Specifically, in the same way as the above-described embodiment, in this embodiment, the main stimulation is electrical stimulation that can be adjusted the stimulation intensity from 0 to a preset maximum intensity, and the auxiliary stimulation is vibration stimulation. However, the present disclosure is not limited to this combination of main stimulation and auxiliary stimulation, and the main stimulation may be electrical stimulation, and the auxiliary stimulation may be vibration stimulation or sound stimulation, and further, the main stimulation may be stimulation that is different from electrical stimulation.

In the present disclosure, delivery of main stimulation exceeding the maximum intensity is required, for example, in the following situation.

First, the user may adjust the intensity of the main stimulation to a desired intensity (level) using the dial 230 while seeing the intensity (level) indication displayed on the 7-segment icon 282 at the center of the display 280 as described above, and the adjusted intensity may exceed the currently set maximum intensity. Subsequently, when executing the above-described M Mode, C Mode or R Mode by pressing the predetermined function button 220, delivery of the main stimulation exceeding the current maximum intensity may be required.

Additionally, the current stimulation intensity set using the dial 230 is equal to or less than the maximum intensity, and when executing the Boost Mode (M+Mode, C+ Mode, R+ Mode) in which main stimulation of increased level by a preset level in each stimulation mode (M, C, R mode) is delivered through the electrode 123 of the animal training apparatus 100′, the increased level may exceed the maximum intensity, and delivery of the main stimulation exceeding the current maximum intensity may be required.

In this situation, the microprocessor 210 of the remote controller 200 transmits a signal for delivering the maximum intensity of main stimulation and auxiliary stimulation together to the animal training apparatus 100′ through the wireless communication module 240 of the remote controller 200, and the microprocessor 110′ of the animal training apparatus 100′ having received the signal through the wireless communication module 180 of the animal training apparatus 100′ controls the main stimulation generator/stimulator module (the electrical stimulation generator/stimulator module) and the auxiliary stimulation generator/stimulator module (the vibration stimulation generator/stimulator module) to generate the maximum intensity of main stimulation (electrical stimulation) and the auxiliary stimulation (vibration stimulation) together and deliver them to the animal.

In this instance, the 7-segment icon 282 of the display 280 indicates the intensity (i.e., the maximum intensity) of main stimulation actually delivered by the animal training apparatus 100′, and an icon (any one of M, C, R, M+, C+ and R+) of the corresponding mode among icons 281 of English alphabet and symbol ‘+’ arranged at the upper part of the display 280 and a V icon representing that vibration stimulation is delivered may be lighted up.

As described above, the animal training system of this embodiment may also automatically auxiliary stimulation in addition to main stimulation, thereby effectively correcting the animal's behavior without physical, temporal and psychological burden involved in changing the stimulation mode using a stimulation mode selection switch or precisely adjusting the dial 230 in an emergency situation, in particular, when the user is unable to use two hands freely.

Additionally, also in this embodiment, there is a supplementary effect of the use of vibration stimulation as the auxiliary stimulation, i.e., the improved contact between the electrode 123 of the animal training apparatus 100′ and the animal's skin.

Hereinabove, the animal training apparatus and the animal training system according to the present disclosure has been described. While the present disclosure has been described by particular embodiments, various modifications and changes may be made to the present disclosure by person having ordinary skill in the technical field to which the present disclosure belongs without departing from the spirit and scope of the present disclosure. Therefore, the present disclosure is not limited to the scope narrower than the scope of the appended claims.

What is claimed is:

1. An animal training apparatus which is worn on an animal to deliver stimulation for correcting the animal when the animal does or does not do a particular behavior, the animal training apparatus comprising:
a main stimulation generator/stimulator module configured to generate an intensity adjustable main stimulation and deliver the main stimulation to the animal;
an auxiliary stimulation generator/stimulator module configured to generate a different type of auxiliary stimulation from the main stimulation and deliver the auxiliary stimulation to the animal; and
a microprocessor configured to control the main stimulation generator/stimulator module and the auxiliary stimulation generator/stimulator module to deliver the main stimulation and/or the auxiliary stimulation to the animal when a preset condition is satisfied,
wherein when delivery of the main stimulation exceeding a maximum intensity is required, the microprocessor is configured to control the main stimulation generator/stimulator module and/or the auxiliary stimulation generator/stimulator module to automatically generate the maximum intensity of main stimulation and the auxiliary stimulation together.

2. The animal training apparatus according to claim 1, wherein the main stimulation is electrical stimulation, and the auxiliary stimulation is vibration stimulation and/or sound stimulation.

3. The animal training apparatus according to claim 1, wherein the main stimulation is electrical stimulation, and the auxiliary stimulation is vibration stimulation.

4. The animal training apparatus according to claim 1, further comprising:
a sensor to detect whether the animal did or did not do the particular behavior, and
wherein the microprocessor determines whether the preset condition is satisfied based on a signal outputted from the sensor.

5. The animal training apparatus according to claim 1, wherein the microprocessor is configured to control the main stimulation generator/stimulator module to generate the main stimulation with a higher intensity by a predetermined intensity than a current intensity, when the main stimulation generator/stimulator module repeatedly generates the main stimulation within a predetermined time.

6. The animal training apparatus according to claim 1, further comprising a memory,
wherein the microprocessor stores an operation history in the memory, the operation history including a time at which the animal training apparatus operated and an intensity of stimulation at that time.

7. The animal training apparatus according to claim 1, wherein the maximum intensity can be set by a user.

8. An animal training system comprising an animal training apparatus worn on an animal to deliver stimulation to the animal and a remote controller possessed by a user to control the animal training apparatus, the remote controller and the animal training apparatus configured to communicate with each other via wireless communication,
the animal training apparatus comprising:
a main stimulation generator/stimulator module configured to generate an intensity adjustable main stimulation and deliver the main stimulation to the animal;
an auxiliary stimulation generator/stimulator module configured to generate a different type of auxiliary stimulation from the main stimulation and deliver the auxiliary stimulation to the animal;
a wireless communication module configured to receive a signal from the remote controller; and
a microprocessor configured to control the main stimulation generator/stimulator module and the auxiliary stimulation generator/stimulator module to deliver the main stimulation and/or the auxiliary stimulation to the animal based on the signal received by the wireless communication module, and
the remote controller comprising:
a user input means to select a particular stimulation mode from a plurality of stimulation modes differing in type, intensity or duration of the stimulation to be delivered by the animal training apparatus or a particular function from a plurality of functions provided by the animal training system and input an execution command of the selected stimulation mode or function;
a wireless communication module to transmit signals indicating the stimulation mode or function selected by the user input means to the animal training apparatus; and
a microprocessor to process the signals and control the wireless communication module,
wherein when the stimulation mode or function selected by the user input means requires delivery of the main stimulation exceeding a maximum intensity, the microprocessor of the remote controller controls to transmit a signal for delivering the maximum intensity of main stimulation and the auxiliary stimulation together to the animal training apparatus through the wireless communication module of the remote controller.

9. The animal training system according to claim 8, wherein the main stimulation is electrical stimulation, and the auxiliary stimulation is vibration stimulation and/or sound stimulation.

10. The animal training system according to claim 8, wherein the main stimulation is electrical stimulation, and the auxiliary stimulation is vibration stimulation.

11. The animal training system according to claim 8, wherein the user input means of the remote controller includes a dial to adjust the intensity of the main stimulation to be delivered to the animal, and
when the user sets the intensity exceeding the maximum intensity using the dial and inputs an execution command to deliver the main stimulation, the microprocessor of the remote controller controls to transmit a signal for delivering the maximum intensity of main stimulation and the auxiliary stimulation together to the animal training apparatus.

12. The animal training system according to claim 8, wherein the plurality of stimulation modes includes Boost Mode in which the intensity of the main stimulation to be delivered to the animal that is higher than a currently set intensity by a predetermined amount is delivered, and
when the user inputs an execution command of the Boost Mode and the intensity increased by the predetermined amount in the Boost Mode is the intensity exceeding the maximum intensity, the microprocessor of the remote controller controls to transmit a signal for delivering the maximum intensity of main stimulation and the auxiliary stimulation together to the animal training apparatus.

13. The animal training system according to claim 8, wherein the remote controller further includes a memory, and
the microprocessor of the remote controller stores an operation history in the memory, the operation history including a time at which the animal training apparatus operated and an intensity of stimulation at that time.

14. The animal training system according to claim 8, wherein the maximum intensity can be set by the user through the user input means.
